(19) United States
(12) Patent Application Publication
(10) Pub. No.: US 2011/0129125 A1
(43) Pub. Date: Jun. 2, 2011

(54) BIOCHIP DETECTION SYSTEM WITH IMAGE CORRECTION UNIT AND DISTORTED IMAGE CORRECTING METHOD USING THE SAME

(76) Inventors: Soo Kyung KIM, Gyeonggi-do (KR); Won Hyung CHO, Seoul (KR); In Gyu KIM, Seoul (KR); Seong Pil HEO, Gyeonggi-do (KR)

(21) Appl. No.: 12/628,314

(22) Filed: Dec. 1, 2009

(51) Int. Cl. G06K 9/00

(52) U.S. Cl. 382/115; 382/275

(57) ABSTRACT

The present disclosure relates to a biochip detection system capable of correcting a distorted part of detection data acquired by a detection stage rotated at high speed for detecting bio-information of the biochip, and a method of correcting the distorted image of the detection data using the same. The biochip detection system with a rotatable detection stage capable of loading at least one biochip thereon to detect information of the biochip by emitting light includes a detector detecting and converting light reflected from the biochip into a detection signal, an image data unit converting the detection signal into image data, and an image correction unit correcting a distorted image of the detection signal. The biochip detection system can correct an image, which is distorted during detection of the high-speed rotatable detection stage, into an orthogonal image, so that more accurate and reliable bio-information can be quickly acquired.

### BACKGROUND OF THE INVENTION

1. Field of the Invention

The present invention relates to a biochip detection scanner with a high-speed rotatable detection stage for detecting information about a biochip and, more particularly, to a biochip detection system and an image correcting method of the same, which is capable of quickly acquiring more accurate and reliable bio-information by correcting a distorted image, detected in a high-speed rotatable detection stage for recognizing bio-information about a biochip, into an orthogonal image.

2. Description of the Related Art

A biochip is a chip in which a probe for bio-molecules, such as deoxyribo nucleic acid (DNA), protein, and the like, is attached at high density to a substrate to analyze a gene expression pattern, a gene defect, a protein distribution, a reaction pattern, and the like in a sample. According to probe attachment types, the biochip is classified into a microarray chip where the probe is attached to a solid substrate and a lab-on-a-chip where the probe is attached to a microchip. In the biochip, a biomaterial including hexane or the like is fixed to a substrate. A DNA chip is one well-known type of biochip and is formed by attaching DNA to the substrate. A protein chip is formed by fixing protein on a substrate.

For the biochip, there is a need for a system capable of detecting whether the probe fixed to the substrate is bonded to a target molecule, in order to determine whether the target molecule capable of being bonded to the probe is present in a sample.

A general method of reading out information about the biochip is to detect fluorescence of a fluorescent material contained in probe molecules. As a representative one of such methods, a laser-induced fluorescence detection method employs a laser as a source for excitation of light having a wavelength to be absorbed by a fluorescent material, and measures the intensity of fluorescence emitted when the fluorescent material changes from an excited state to a ground state. This method can provide information about a degree of binding between the fixed probe and the target probe, i.e., bio-information, based on the intensity of fluorescence.

A confocal laser scanning system is the most representative apparatus based on the laser-induced fluorescence detection method for detecting fluorescence. The confocal laser scanning system employs a laser as a light source, receives a fluorescent signal emitted from a sample through a photomultiplier tube (PMT), which is a separate detector, and converts the fluorescent signal into a digital image through an analog/digital (A/D) converter.

In one example of the methods for detecting the DNA chip as disclosed in U.S. Pat. No. 6,141,096, sample DNA is labeled by a fluorochrome and is subjected to reaction with the probe on the chip, followed by detection of a remaining fluorescent material on the chip using a confocal microscope or a charge coupled device (CCD) camera.

However, since such an optical detection method makes it difficult to reduce the size of the system thereof and does not provide digitized outputs, studies have been conducted into development of new detection methods capable of outputting results via electric signals.

Many institutes including Clinical Micro Sensor have been carrying out investigations on a method of electrochemically detecting DNA hybridization using metal compounds susceptible to oxidation and reduction (see U.S. Pat. Nos. 6,096,273 and 6,090,933). In this method, when DNA is hybridized, a compound containing a metal susceptible to oxidation and reduction constitutes a complex therewith, which is in turn electrochemically detected. However, this method has a drawback in that it also needs a separate labeling process.

Additionally, it has also been actively investigated to develop various analysis methods that do not use the fluorochrome or other marker materials. For instance, there is a method of measuring, based on quartz crystal microbalance, a difference between masses before and after bonding.

Since a fluorescent signal emitted from the fluorochrome often becomes weak depending on detection conditions, environmental changes, etc., it is necessary for a biochip scanner based on the laser-induced fluorescence detection method to use a detector such as an expensive and sensitive PMT for sensing the fluorescent signal and many optical components for detecting a fixed degree, such as a dichronic filter, an emission filter, and the like, which cause an increase in manufacturing costs while complicating a detection condition to obstruct generalization of the scanner.

In particular, a conventional method of recognizing information about a biochip projects a laser beam or the like to a substrate and reads out information about each of biochips by linearly scanning an upper portion of the biochip in application of a scanning method using the laser beam. Thus, the conventional method is very inefficient since it takes considerable time to read out information for each biochip. That is, since an optical pickup unit scans the surface of the biochip from the upper portion to a lower portion thereof while moving in a left-right direction, a detection speed is inevitably lowered significantly.

In the conventional linear (straight-line) detection method, the optical pickup unit is placed at a predetermined height from the biochip and moves left and right to scan the biochips one by one with linear motors arranged therein. Thus, it is not only difficult to perform high-speed scanning but also impossible to scan a plurality of biochips.

To solve these problems, the present applicant filed a biochip scanner including a rotatable stage as shown in FIG. 1, and the present invention relates to a method and system for more reliably correcting an image of this biochip scanner.

In other words, the high-speed-rotatable biochip scanner is provided with the method and system for correcting distorted image-information scanned during rotation according to embodiments of the present invention.

### SUMMARY OF THE INVENTION

The present invention is directed to solving the problems of the related art, and an aspect of the present invention is to provide a biochip detection system with a rotatable stage, which can form a more accurate and reliable image by correcting distortion of bio-information images while simultaneously detecting biochip information of biochips in a rotation manner, thereby enhancing speed and reliability of detection.

In accordance with one aspect of the invention, a biochip detection system with a rotatable detection stage capable of loading at least one biochip thereon to detect information of the biochip by emitting light includes: a detector detecting and converting light reflected from the biochip into a detection signal; an image data unit converting the detection signal into image data; and an image correction unit correcting a distorted image of the detection signal, so that the distorted image detected on the high-speed rotatable detection stage for recognizing bio-information of the biochip can be corrected into an orthogonal image, thereby quickly acquiring more accurate and reliable bio-information.

The image correction unit may include an image cutter cutting raw data of detected images from the image data unit into a unit data image for each biochip; and an image converter converting respective cut images of the raw data into an orthogonal array, thereby correcting the distorted image by rotation into the orthogonal image.

The image cutter may cut the raw data by setting a cutting range as a unit of a row in a scanned section of the optically detected biochip. Here, the range is obtained by Expression 1:

Xi=Xo*Ro/Ri

where Xi is a range of a current row, Xo is a length of an ideal range scanned on the outer periphery, Ro is a radius to the outer periphery, and Ri is a radius of the current row. The image cutter can solve a problem that an overlap-scanning area increases and an image corresponding to the scanned section becomes elongated as it goes from the outer periphery to the inner periphery due to scanning at a constant angular velocity, thereby enabling the raw data to be cut in a scan range corresponding to an accurately required section.

The image converter may perform a first image conversion of reducing Xi into Xo through bilinear interpolation; and a second image conversion of correcting an error in an arc length of the raw data. Thus, it is possible to correct an error that may occur when the outer and inner peripheries of the detected raw image data are read out at the same angular velocity.

The image data unit may include an analog/digital converter (ADC) converting a detection signal into a digital value; and a synchronous signal unit transmitting data of a detection signal by a block.

The biochip detection system may further include a high-speed data processor for data-blocking, temporarily storing, and transmitting a digitalized detection signal to another host, thereby enhancing operation efficiency of the system.

The high-speed data processor may include a buffer memory temporarily storing the blocked data, and a data communication unit transmitting data at high speed.

The biochip detection system may further include a data storage storing data to be transmitted, and an analysis program analyzing the stored data to analyze bio-information.

The biochip detection system may further include a controller controlling the entire system.

In accordance with another aspect, a method of correcting an image detected by a rotatable biochip detection system includes: detecting an image of at least one biochip mounted on a rotatable stage as raw data in an optical pickup unit; cutting the raw data to be sorted corresponding to each biochip mounted on the rotatable stage; and converting rotary data of the sorted data of the biochip into an orthogonal array, thereby correcting distortion of a bio-information image detected in a rotational manner to acquire detection information with high reliability.

The detecting an image of at least one biochip may include cutting the image of the biochip by calculating a range of a region where bio-information of each biochip is scanned while being rotated in a unit of row, thereby efficiently catching the bio-information within an effective range.

The image may be cut as much as Xi corresponding to the range of the scanned region calculated by Expression 2:

Xi=Xo*Ro/Ri

where Xi is a range of a current row, Xo is a length of an ideal range scanned on the outer periphery, Ro is a radius to the outer periphery, and Ri is a radius of the current row.

The converting rotary data may include a first image correction to correct an error by reducing Xi into Xo through bilinear interpolation.

The converting rotary data may further include a second image correction to correct an error in an arc length of each raw data after the first image conversion.

### BRIEF DESCRIPTION OF THE DRAWINGS

The above and other aspects, features and advantages of the invention will become apparent from the following description in conjunction with the accompanying drawings, in which:

FIGS. 1 to 4 show a biochip detection system (scanner) with a high-speed rotatable stage according to one embodiment of the present invention;

FIG. 5 shows a scanning method of the biochip detection system with the high-speed rotatable stage according to an embodiment of the present invention;

FIGS. 6a to 6c show various biochip detection methods;

FIG. 7 is a block diagram of a biochip detection system with an image correction unit according to one embodiment of the present invention;

FIG. 8 shows a sensor signal and data sorting in the biochip detection system according to the embodiment of the present invention;

FIGS. 9a and 9b show a method of correcting rotational detection data in the biochip detection system according to an embodiment of the present invention;

FIGS. 10a to 10e show a method of correcting the rotational detection data in the biochip detection system.

### DETAILED DESCRIPTION OF THE EMBODIMENTS

A biochip scanner with a rotatable stage according to one embodiment of the invention will be described and a method of solving the problem will be proposed.

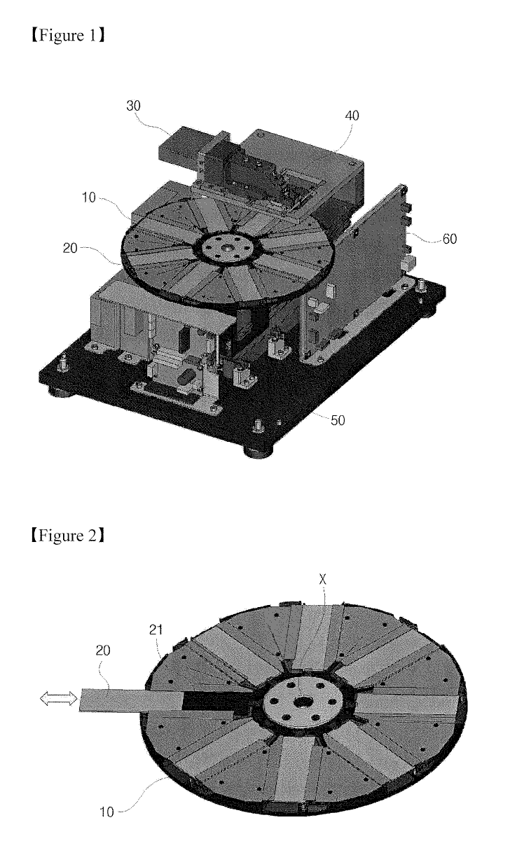

Referring to FIG. 1, a biochip scanner according to one embodiment of the invention includes a plate-shaped stage 10 that is capable of rotating at high speed and includes at least one biochip mounted thereon. When the stage 10 including the biochip is rotated at high speed, an optical pickup unit 40 emits light and an optical detector 30 detects bio-information based on the reflected light. For detection of the optical pickup 40 from the center of the stage 10, i.e., from a rotational center, the scanner is provided with a disc transfer motor 50 which transfers the stage 10. In the biochip detection system of the embodiment, a plurality of biochips are mounted on the detection stage rotating at high speed, so that information of the biochips can be simultaneously detected in a rotational manner, thereby enhancing detection speed while reducing manufacturing costs.

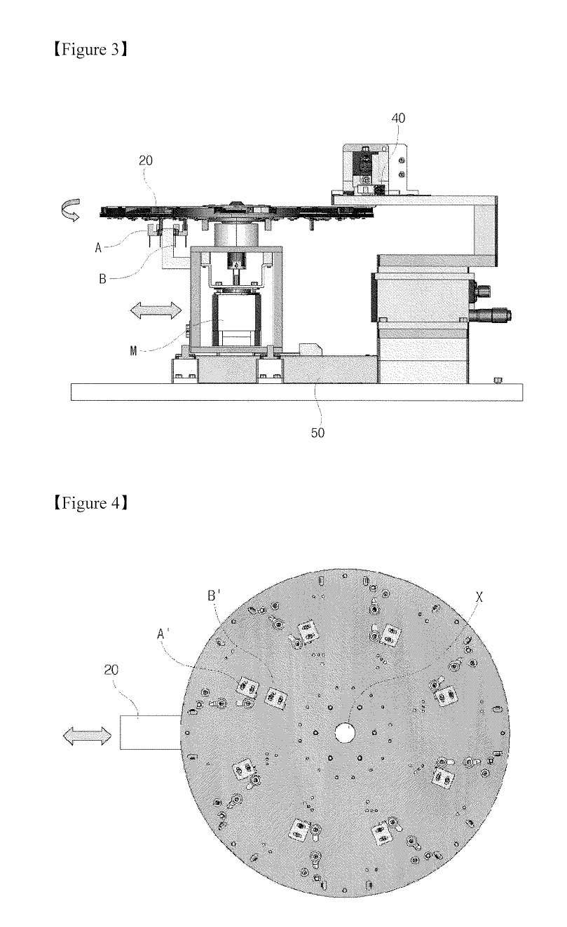

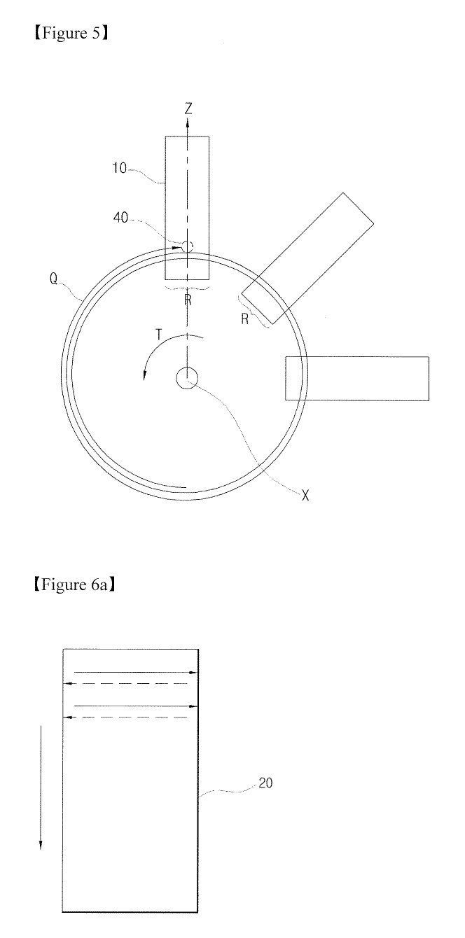

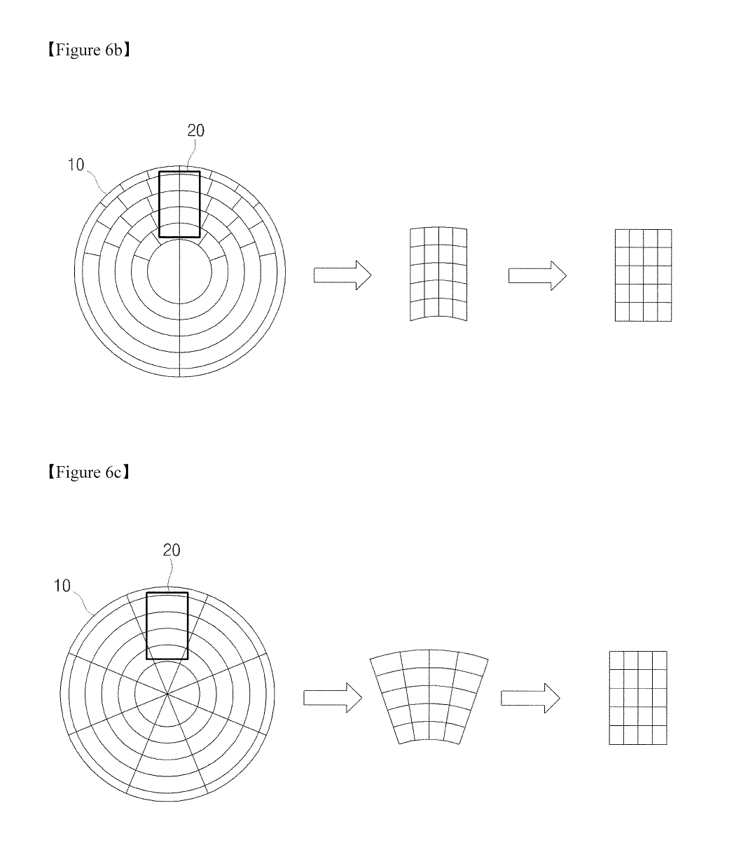

FIG. 2 shows a stage 10 on which a biochip 20 is mounted. The stage 10 is adapted to mount at least one biochip thereon, and the biochip may be fixedly inserted into a stable mounting part on the surface of the stage 20. In the rotatable biochip scanner as shown in FIG. 3, a biochip position sensor A is placed at a lower portion of a disc plate, on which the biochip 20 is mounted, and detects a groove sensor dog to generate a signal. Further, a biochip position sensor B detects a position sensor dog to generate a signal. Referring to FIG. 4, a groove position sensor dog A′ is provided to generate a signal from the sensor for recognizing a groove position of the biochip, and a single groove position sensor dog A′ is provided to recognize a position of a first chip. A position sensor dog B′ is provided to generate a signal to the sensor for recognizing a position of each of the biochips, and the number of position sensor dogs B′ may be equal to the number of chip holders.

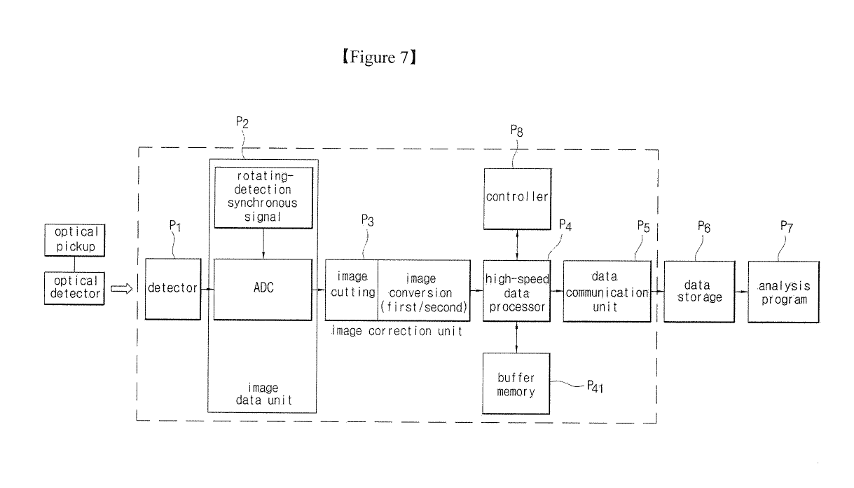

Referring to FIG. 5, which schematically shows a method of scanning a biochip by the system according to the embodiment, when biochips mounted on the stage rotate at a high speed about a rotational center X of the stage, a pickup point in the optical pickup unit 40 is fixed to a lower end of each of the biochips. When the disc is transferred via an internal transfer motor (in a Z-direction), bio-information of the biochips is sequentially scanned along a detection scan track Q.

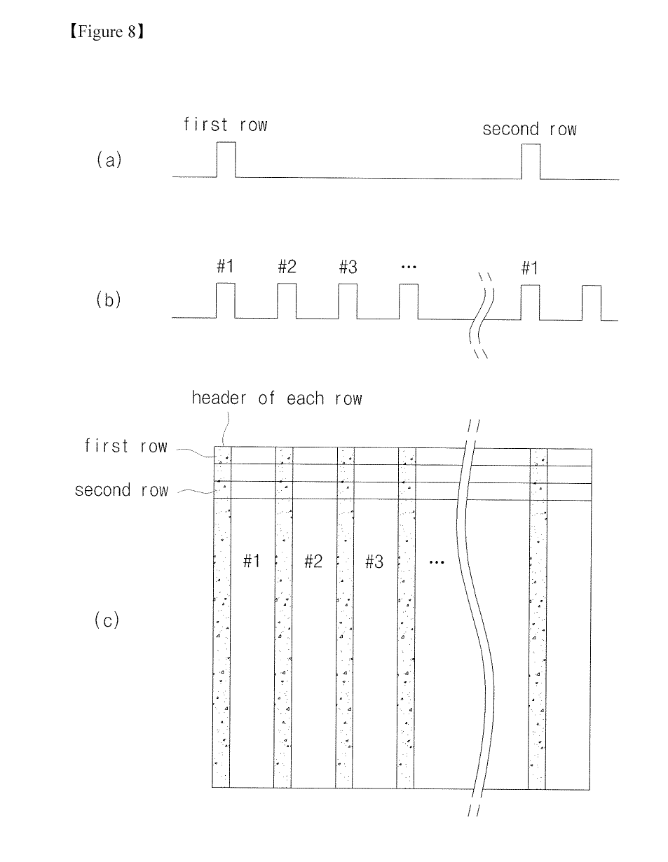

Referring to FIG. 6a, in a conventional linear (straight line) detection method, the optical pickup unit is placed at a predetermined height from the biochip and moves left and right while scanning the biochips one by one with the linear motor arranged therein. Thus, it is not only difficult to perform high-speed scanning but also impossible to scan a plurality of biochips.

On the other hand, in the high-speed rotatable biochip scanner according to the embodiment of the invention, with the biochips mounted on the stage, bio-information thereof can be acquired by the optical pickup unit while the stage is rotated at a high speed.

To acquire the bio-information depending on a rotational speed of the stage, a constant linear velocity rotation control method (see FIG. 6b) or a constant angular velocity rotation control method (see FIG. 6c) may be used. In the constant linear velocity rotation control method, the optical pickup unit detects the bio-information of the biochips on the stage rotating at a constant linear velocity corresponding to a detection radius. In the constant angular velocity rotation control method (see FIG. 6c,) the stage rotates at a constant velocity regardless of the detection radius.

Referring to FIG. 6b, in the constant linear velocity control method, the stage is detected by the optical pickup unit and is rotated to keep the linear velocity constant corresponding to radius thereof. In this method, since a constant number of data is detected in a width direction of the biochip, it is advantageous that the number of sampling data be uniform. However, there is a drawback in that a configuration of detected data is distorted by the rotation. Thus, it is necessary to correct the distorted data when acquiring final data.

In FIG. 6c, in the constant angular velocity control method, the stage rotates at a normal speed irrespective of the detection radius position of the optical pickup unit. In this method, it is easy to perform rotation control and keep the rotation speed constant even for a large and heavy stage. However, in even this method, the detected data may also be distorted and an error may occur when sorting the data since there is a difference between the number of data detected on inner and outer peripheries. Accordingly, there is a need for data correction when acquiring final data. That is, when the detected signal is digitized, it is possible to see the detected data as an image. When the data obtained by the rotational detection under the constant angular velocity control or the constant linear velocity control is converted into an image, it can be seen that the image is distorted by rotation. To analyze the image with a commercial analysis program, the distorted image obtained by the rotational detection must be corrected into an orthogonal image.

In the embodiment of the invention, the system can quickly acquire more accurate and reliable bio-information by correcting the distorted image, which is detected on the high-speed rotatable detection stage, into the orthogonal image, thereby enhancing operation efficiency.

Next, a configuration and operation of a biochip detection system according to one embodiment of the invention will be described with reference to the accompanying drawings.

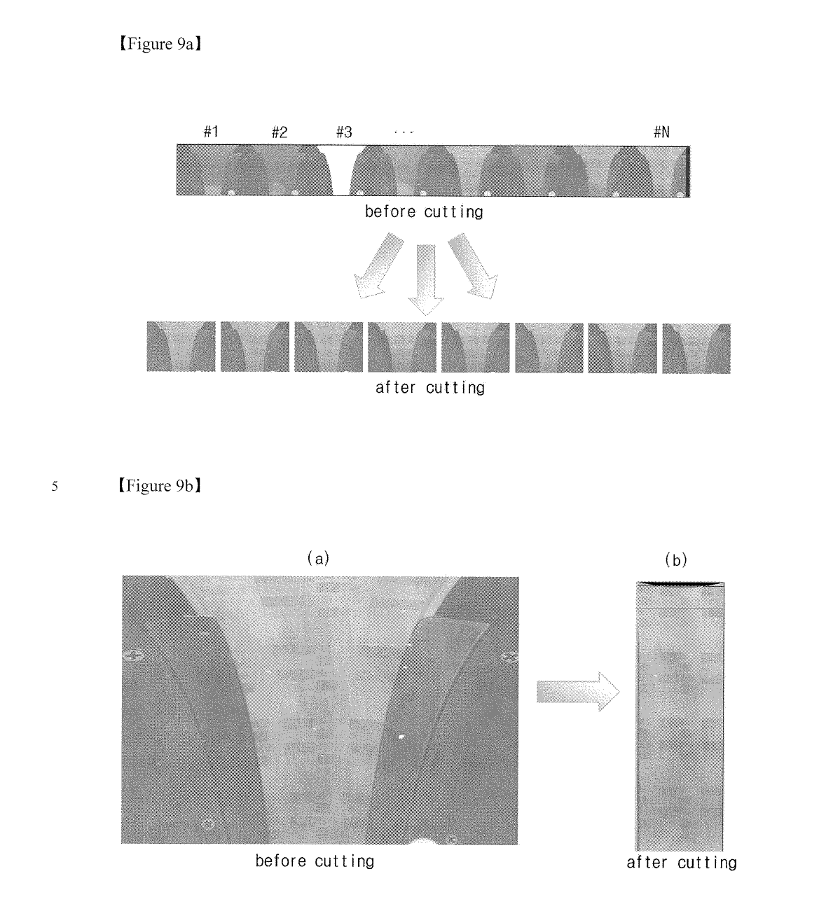

FIG. 7 is a block diagram of a biochip detection system with an image correction unit according to one embodiment of the invention.

The biochip detection system rotatable at high speed includes a detector P1 that detects a signal via optical pickup. The detector P1 detects light reflected from the biochip and converts the reflected light into a detection signal.

Further, the biochip detection system includes an image data unit P2. The image data unit P2 includes an analog/digital converter (ADC) that converts the detection signal detected in the detector P1 into a digital value, and a rotating-detection synchronous signal unit that acts as a synchronous signal unit for transmitting data in a block unit based on signals from the aforementioned biochip groove position sensor and biochip position sensor.

The biochip detection system further includes an image correction unit P3 that corrects a distorted image of the detected signal. The image correction unit P3 includes an image cutter for cutting an image detected by the image data unit P2, i.e., raw data into a unit data image for each biochip, and an image converter for converting the respective cut raw data images into an orthogonal array.

The biochip detection system may further include a high-speed data processor P4 for data-blocking, temporarily storing, and transmitting the converted detection signal to another host, a buffer memory P41 for temporarily storing the blocked data, a communication unit P5 for transmitting the data to another host at high speed, a data storage P6 as a storage of the host for storing the received data, and an analysis program P7 as software for analyzing bio-information by analyzing the stored data.

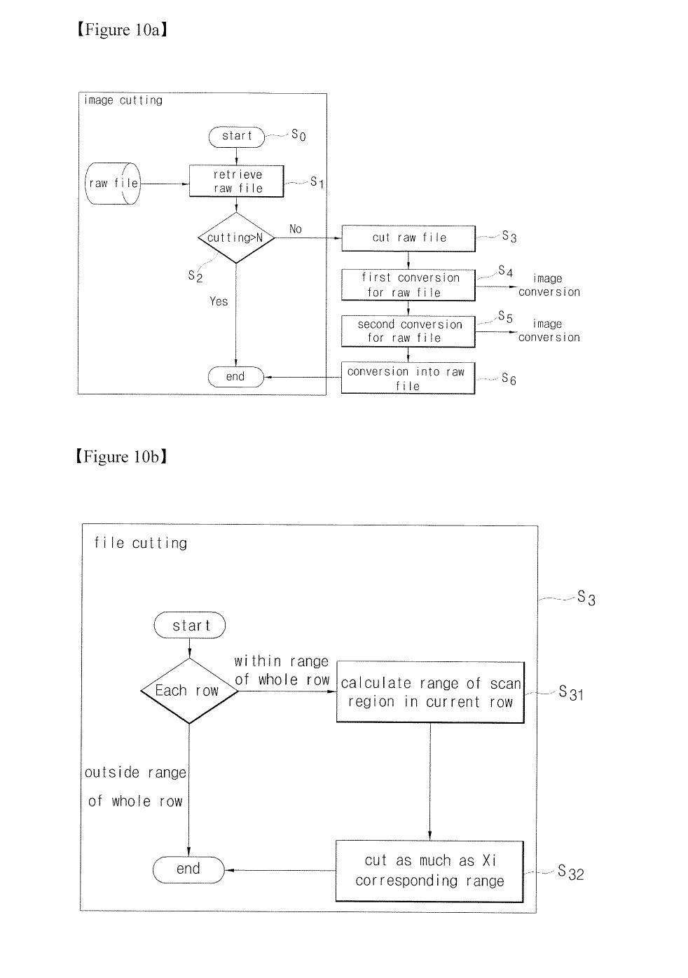

FIG. 8 schematically shows biochip groove position sensor signals, biochip position sensor signals, and data sorting.

Referring to FIG. 8, (a) shows the biochip groove position sensor signals, (b) shows the biochip position sensor signals, and (C) shows that detection data is sorted in rows and lines, where the row means partial data detected in a certain biochip when rotated once, and a header may be given to the data by each position sensor signal as shown therein. Further, only one header may be given with respect to the whole data, and alternatively, the header may be absent. The line means the position of each biochip determined in response to a synchronous signal.

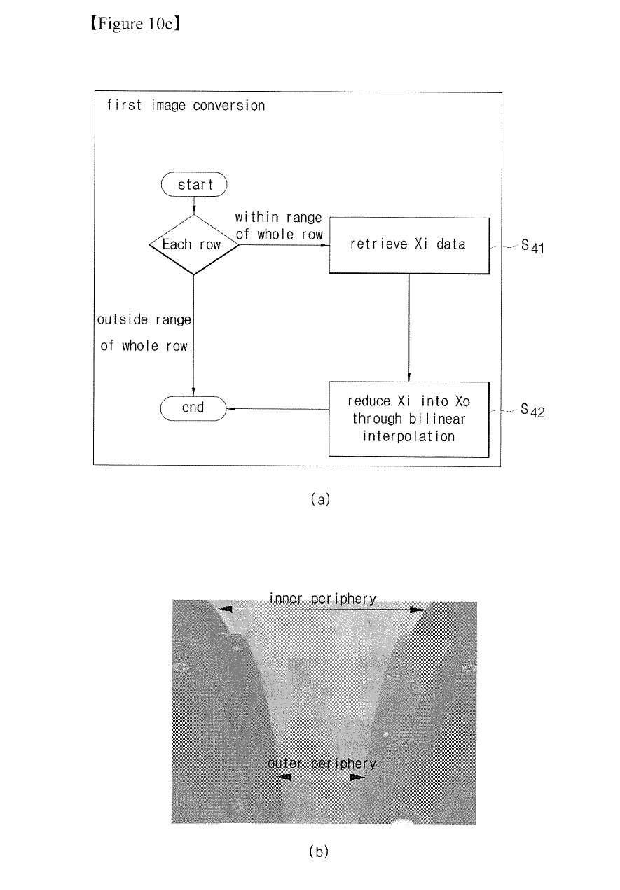

FIG. 9a is photographs showing that the raw data is cut in a method of correcting a distorted image according to an embodiment of the invention. That is, the detected data is sorted into individual biochip data. In FIG. 9a, an upper photograph shows data before cutting, and a lower photograph shows data after cutting.

FIG. 9b shows that raw data (a), i.e., distorted data due to rotation, is converted into an orthogonal array (b). As shown therein, the image of the rotary data becomes more distorted as it goes from the outer periphery to the inner periphery, and when the distorted image is converted into the orthogonal array according to the range of the outer periphery, the corrected image can be acquired as shown in (b). Next, a method of cutting and converting the detection data, i.e., the raw data will be described in more detail with reference to a flowchart.

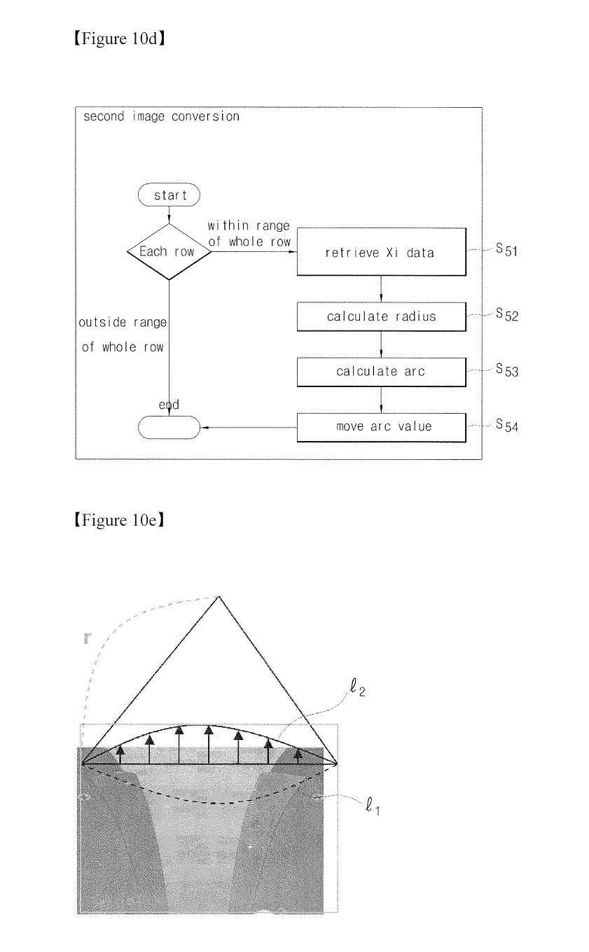

FIG. 10a is a flowchart of a method of correcting a distorted image of raw data acquired by rotational detection according to one embodiment of the invention. In this method, a raw file, i.e., raw data, is retrieved in S0 and S1, cut as much as the number (N) of biochips in S2 and S3, is subjected to conversion in S4 and S5, respectively. Then, the converted data is converted into a file in TIFF format (S6). As a result, the distorted image is completely corrected.

The processes in S2 and S3, i.e., operations of cutting the raw data (raw file), will be described in more detail. If a range scanned in each row is within the whole row range, the range of the current row scanning region is calculated, so that the raw data can be cut as much as the current row range according to the calculated range. When cutting the raw data by calculating the cutting range of the raw data, an overlap-scanning area increases and an image corresponding to the scanned section becomes elongated from the outer periphery to the inner periphery due to scanning at a constant angular velocity. Thus, the length of the scanned section in each increases in inverse proportion to the radius, so that the range can be calculated by Expression 1:

Xi=Xo*Ro/Ri

where Xi is a range of a current row, Xo is a length of an ideal range scanned on the outer periphery, Ro is a radius to the outer periphery, and Ri is a radius of the current row.

Next, the process in S4, i.e., an operation of converting a first image, will be described with reference to FIG. 10c.

The raw data acquired by rotational scanning has a distorted region by the rotation, in which an error occurs because the outer periphery and the inner periphery are scanned at different angular velocities. That is, since a raw file signal of H/W is processed with reference to the sampling of the outer periphery, it is necessary to correct the sampling of the inner periphery with reference to the sampling of the outer periphery. (In FIG. 10c, (b) shows the outer and inner peripheries of the raw data, and small amounts of data are acquired in the outer periphery and large amounts of data are acquired in the inner periphery when data is read out in a high-speed rotating region.)

In this correcting method, if each row is within the whole row range, the foregoing Xi is reduced into Xo through bilinear interpolation.

The bilinear interpolation is implemented as follows.

Xorg=1/Sx*Xnew

Yorg=1/Sy*Ynew

This expression relates to reverse mapping. If scales Sx and Sy are given in x and y directions, coordinates of an original image can be obtained by substituting values into the expression via the reverse mapping while scanning coordinates of a new image.

Next, the process in S5, i.e., an operation of converting a second image, will be described with reference to FIG. 10d.

In S5, an error is corrected by retrieving data of each row within the whole row range (S51), calculating a radius of the retrieved data (S52), calculating the length of an arc (S53), and moving the value of the arc (S54).

Referring to FIGS. 10d and 10e, from the characteristics of rotational scanning, the image is seen as curved since each row read out from each biochip is read out not in the form of a line but in the form of an arc. To solve this problem, a radius “r” corresponding to each row is calculated, an arc 11 corresponding to the radius is calculated, and data of the row is moved to an arc 12. As a result, the data scanned in the form of the arc is expressed as an arc on an image, thereby correcting an error.

In the biochip detection system rotating at high speed for acquiring information of a certain biochip, a distorted image of bio-information about the biochip is corrected into an orthogonal array, thereby correcting the distorted image. That is, the distorted image detected in the high-speed rotatable detection stage for recognizing the bio-information of the biochip is corrected into the orthogonal image, so that the bio-information can be more accurately and reliably acquired. In particular, a plurality of biochips may be mounted on the detection stage, so that information of the biochips can be simultaneously detected in a rotational manner while providing accurate image information through correction of the distorted images, thereby enhancing speed and reliability in detection while reducing manufacturing costs.

As apparent from the above description, the system can correct a distorted image, which is detected on a high-speed rotatable detection stage for recognizing bio-information of biochips, into an orthogonal image, thereby quickly providing more accurate and reliable bio-information.

Particularly, with a plurality of biochips mounted on the high-speed rotatable detection stage, the system detects information of the biochips at the same time in a rotational manner while correcting distorted images to provide accurate image information, thereby enhancing speed and reliability in detection while reducing manufacturing costs.

Although some embodiments have been provided to illustrate the invention, it will be apparent to those skilled in the art that the embodiments are given by way of illustration, and that various modifications and equivalent embodiments can be made without departing from the spirit and scope of the invention. The scope of the invention should be limited only by the accompanying claims and equivalents thereof.

What is claimed is:

1. A biochip detection system with a rotatable detection stage capable of loading at least one biochip thereon to detect information of the biochip by emitting light, comprising:
a detector detecting and converting light reflected from the biochip into a detection signal;
an image data unit converting the detection signal into image data; and
an image correction unit correcting a distorted image of the detection signal.

2. The biochip detection system according to claim 1, wherein the image correction unit comprises:
an image cutter cutting raw data of detected images from the image data unit into a unit data image for each biochip; and
an image converter converting the respective cut raw data images into an orthogonal array.

3. The biochip detection system according to claim 2, wherein the image cutter cuts the raw data by setting a cutting range as a unit of a row in a scanned section of an optically detected biochip, the range being obtained by Expression 1:
Xi=Xo*Ro/Ri
where Xi is a range of a current row, Xo is a length of an ideal range scanned on the outer periphery, Ro is a radius to the outer periphery, and Ri is a radius of the current row.

4. The biochip detection system according to claim 3, wherein the image converter performs a first image conversion of reducing Xi into Xo through bilinear interpolation, and a second image conversion of correcting an error in an arc length of the raw data.

5. The biochip detection system according to claim 4, wherein the image data unit comprises
an analog/digital converter (ADC) converting a detection signal into a digital value; and
a synchronous signal unit transmitting data of a detection signal by a block.

6. The biochip detection system according to claim 5, further comprising:
a high-speed data processor for data-blocking, temporarily storing, and transmitting a digitized detection signal to another host.

7. The biochip detection system according to claim 6, wherein the high-speed data processor comprises a buffer memory temporarily storing the blocked data, and a data communication unit transmitting data at high speed.

8. The biochip detection system according to claim 7, further comprising:
a data storage storing data to be transmitted; and
an analysis program analyzing the stored data to analyze bio-information.

9. The biochip detection system according to claim 8, further comprising: a controller controlling a whole system.

10. A method of correcting an image detected by a rotatable biochip detection system, comprising:
detecting an image of at least one biochip mounted on a rotatable stage as raw data in an optical pickup unit;
cutting the raw data to be sorted corresponding to each biochip mounted on the rotatable stage; and
converting rotary data of the sorted data of the biochip into an orthogonal array.

11. The method according to claim 10, wherein the detecting an image of at least one biochip comprises cutting the image of the biochip by calculating a range of a region where bio-information of each biochip is scanned while being rotated in units of rows.

12. The method according to claim 10, wherein the image may be cut as much as Xi corresponding to the range of the scanned region calculated by Expression 2:
Xi=Xo*Ro/Ri
where Xi is a range of a current row, Xo is a length of an ideal range scanned on the outer periphery, Ro is a radius to the outer periphery, and Ri is a radius of the current row.

13. The method according to claim 12, wherein the converting rotary data comprises a first image correction to correct an error by reducing Xi into Xo through bilinear interpolation.

14. The method according to claim 13, wherein the converting rotary data further comprises a second image correction to correct an error in an arc length of each raw data after the first image conversion.
